(19) United States
(12) Patent Application Publication
(10) Pub. No.: US 2014/0201203 A1
(43) Pub. Date: Jul. 17, 2014

(54) SYSTEM, METHOD AND DEVICE FOR PROVIDING AN AUTOMATED ELECTRONIC RESEARCHER

(71) Applicants: Prafulla Krishna, San Francisco, CA (US); Christopher Hess, Larkspur, CA (US); Rathinakumar Appuswamy, Sunnyvale, CA (US)

(72) Inventors: Prafulla Krishna, San Francisco, CA (US); Christopher Hess, Larkspur, CA (US); Rathinakumar Appuswamy, Sunnyvale, CA (US)

(21) Appl. No.: 14/156,231

(22) Filed: Jan. 15, 2014

Related U.S. Application Data
(60) Provisional application No. 61/752,912, filed on Jan. 15, 2013.

(51) Int. Cl. G06F 17/30

(52) U.S. Cl. CPC G06F 17/30528
USPC 707/729

(57) ABSTRACT

A research system, method and device directed to providing a query results tree of logical dependencies in response to one or more user queries. Specifically, the research system includes a searcher module, an inference module, a front-end module and an updater module. A user query is received by the front-end module and forwarded to the searcher and inference modules, which in addition to obtaining related results from one or more databases, filter and structure the results such that only highly relevant results are returned and that those results are already organized into one or more hierarchical structures for navigation by the user. In addition, the updater module is able to periodically cause any new data on the databases to be inputted by the search and inference modules and added to the existing results in order to maintain a fully updated results structure.

### RELATED APPLICATIONS

The present application claims priority to U.S. Provisional Patent App. No. 61/752,912, entitled A SYSTEM METHOD AND DEVICE FOR PROVIDING AN AUTOMATED ELECTRONIC RESEARCHER, filed Jan. 15, 2013, which is incorporated herein by reference.

### FIELD OF THE INVENTION

The present invention is in the technical field of automated electronic research. In particular, the present invention relates to an automated electronic research method, system and device for providing an improved query results structure.

### BACKGROUND OF THE INVENTION

Currently, an in-depth research process involves utilizing a query-source paradigm 100. As illustrated in FIG. 1, at a first step 102, a query is identified about a given Context (e.g. topic of interest). Then the query is issued to a Source of information (e.g. an internet search engine) where a search is performed based on the query in step 104. At the step 106, the Source returns initial results often including a list of documents that are largely irrelevant to the Context, are duplicated and are unstructured. For example, if a professional in Financial Services industry (“Analyst”) is interested in researching about the public company, Apple Inc., he or she can enter “apple” at http://www.google.com. In return, the user is presented with a results list including more than 500 million results.

Next in the steps 107-116, the Analyst has to manually peruse and filter those links to identify the relevant documents (steps 107 and 108), note the relevant insight which is only partial in most cases (step 110), read through the documents to identify important items or ideas of his or her topic of interest (112), make a judgment call about which of the dependencies or sub-topics are worth pursuing further (step 114) and manually store the determined partial insights and relevant storage for later reference (step 116). The Analyst has to repeat this Query-Source process 100 for every Source available to him or her, and recursively for every Sub-Topic 114 he or she wishes to investigate, spending considerable amount of time at each step. In the process, the Analyst comes across the same information reproduced by multiple Sources. Further, the Analyst has to repeat the entire process whenever he or she needs an update. The process is inefficient because the Analyst must spend an enormous amount of time collecting information from various sources, deduplicate the documents before he or she can study them carefully. In addition, a careful study of even a small set of documents is a time-consuming exercise.

The number of sources where information relevant to a topic may be obtained is growing vastly and the amount of available data at each source has also seen dramatic increase in recent times driven by a) lowering barriers to disseminating information through public internet or proprietary sources; b) increasingly complex inter-dependencies and globalization; c) higher production, relevance and dissemination of user generated content. Professionals in other industries also use multiple databases, internet Sources, and paid services. They subscribe to email-lists of interest or consume information from other Sources as part of their work and are faced with similar inefficiencies and difficulties to that of the Financial Services. Therefore, although the technological revolution has made it very easy to generate and distribute information, the tools necessary for using the vast amount of information towards better decision making has not been adequately developed.

### SUMMARY OF THE INVENTION

Embodiments of the invention are directed to a research system, method and device that accesses sources of information available to the user, whether public, private or proprietary, to retrieve a set of documents related to a topic (“topical corpus”), infer key logical dependencies for the selected topic and identify a small subset of the topical corpus that represents most of the information contained in the topical corpus, present the results in multiple, job-oriented views to the user across multiple devices, and continuously and incrementally repeat the process of searching and incorporating the new information to results. The results are able to be a set of sentences (“summaries”), documents (collectively “representative corpus”), paragraphs (“prime paragraphs”) or phrases including key logical dependences. The system, method and device is able to compute results by i) removing duplicated information from topical corpus, ii) organizing deduplicated information in multiple hierarchies based on a set of metrics and iii) use the hierarchies to arrive at final set of results.

A first aspect is directed to a research system stored on a non-transitory computer-readable medium. The system comprises a searcher module that automatically searches one or more databases with one or more queries related to a topic and returns a set of result elements including one or more entries from the databases based on the queries, an inference module that organizes the result elements into one or more hierarchical organizational structures based on one or more inference metrics and selects a subset of the result elements as representative results based on a location of the elements in at least one of the hierarchical structures and a front end module that is capable of accepting user inputs and only provides the representative results to the user. In some embodiments, organizing the results comprises categorizing each of the results and assigning a predefined number of the results in each category to the top layer of one of the hierarchical organizational structures. In some embodiments, the inference module organizes the results by ranking each of the sentences within the results according to a sentence metric value of each of the sentences, wherein the sentence metric value is determined according to a sentence metric based on comparing one or more of the sentence and the topic, the sentence and other sentences within the results and the sentence and a set of keywords related to the topic. In some embodiments, the inference module organizes the results by ranking each of the words within the results according to a word metric value of each of the words, wherein the word metric value is determined according to a word metric based on comparing one or more of the word and the topic and the word and other words within the results. In some embodiments, the subset of the elements of the hierarchies is the elements located at the top of at least one of the hierarchical organizational structures. In some embodiments, the topic and each of the results is one or more of the following: a document, a paragraph, a sentence, a phrase or a word, and further wherein the topic is one or more of a document, a paragraph, a sentence, a phrase or a word. In some embodiments, the search module automatically removes duplicates from the results by removing those results that have a metric score whose value when subtracted from the next highest metric score of an element of the results is below a threshold value, wherein the metric scores are determined based on an index metric. In some embodiments, the index metric is symmetric such that the score of two of the elements is independent of the order in which the two elements are compared. In some embodiments, the searcher module applies the index metric to each of the results a plurality of times such that each of the results has a separate metric score for each time the index metric is applied to the result, and further wherein each application of the index metric to a result is based on a different one of words and terms of the result, 2-gram shingles of the result, capitalized words of the result and words and terms grouped by paragraphs of the result. In some embodiments, if a query is greater than a finite length, the searcher module divides each of the queries into a plurality blocks less than or equal to the finite length, searches the databases based on each of the blocks, and combines the individual results found for each of the blocks to construct a final result. In some embodiments, the system further comprises an updater module that automatically causes the searcher module to periodically search the one or more databases with the one or more queries related to the topic and returns an updated set of results based on the queries. In some embodiments, the inference module organizes the updated set of results into one or more updated hierarchical organizational structures based on the one or more inference metrics and selects an updated subset of the newly constructed set of results as representative outputs. In some embodiments, the inference module reorganizes the results into one or more updated hierarchical organizational structures based on a user input received through the front end module. In some embodiments, the databases are determined based on one or more of input from a user, one or more selected metrics or a subscription level associated with the user. In some embodiments, the representative results comprise plurality of elements consisting of sentences, documents, paragraphs, keywords without duplicates. In some embodiments, the inference metric is based on one or more characteristics of the results selected from the group consisting of time of publication, source of the result, interaction of the result with other users, frequency of occurrence of the result in the set of results, frequency of occurrence of the result in the databases, frequency of occurrence of the result in one or more languages, frequency of occurrence of the result along with another result in the set of results, frequency of occurrence of the result along with the another result in the databases, frequency of occurrence of the result along with the another result in one or more languages, external associations between the result and the remainder of the set of results based on pre-defined dictionaries, grammatical classification of the result, the grammatical structure of the result, inclusion of pre-defined stop words in the result, scores or classifications of other results in the hierarchy, alignment to pre-defined hierarchies and the presence of other results within the results set, and/or any other Natural Language Processing based criteria.

Another aspect is directed to a method of implementing a research system. The method comprises, with a computing device, automatically searching one or more databases with one or more queries related to a topic and returning a set of results including one or more entries from the databases based on the queries, organizing the results into one or more hierarchical organizational structures based on one or more inference metrics and selecting a subset of the results as representative results based on a top layer of at least one of the hierarchical organizational structures and receiving user inputs and only providing the representative results to the user. In some embodiments, organizing the results comprises categorizing each of the results and assigning a predefined number of the results in each category to the top layer of one of the hierarchical organizational structures. In some embodiments, the organizing of the results comprises ranking each of the sentences within the results according to a sentence metric value of each of the sentences, wherein the sentence metric value is determined according to a sentence metric based on comparing one or more of the sentence and the topic, the sentence and other sentences within the results and the sentence and a set of keywords related to the topic. In some embodiments, the organizing of the results comprises ranking each of the words within the results according to a word metric value of each of the words, wherein the word metric value is determined according to a word metric based on comparing one or more of the word and the topic and the word and other words within the results. In some embodiments, the subset is a set number of the results at the top of one of the hierarchical organizational structures. In some embodiments, each of the results is one of a document, a paragraph, a sentence, a phrase or a word, and further wherein the topic is one or more of a document, a paragraph, a sentence, a phrase or a word. In some embodiments, the method further comprises automatically removing duplicate results from the results by removing each of the results that have a metric score whose value when subtracted from the next highest metric score of a results of the results is below a threshold value, wherein the metric scores are determined based on an index metric. In some embodiments, the index metric is configured such that a first metric score of one of the results based on another of the results is equal to a second metric score of the another of the results based on the one of the results. In some embodiments, the method further comprises applying the index metric to each of the results a plurality of times such that each of the results has a separate metric score for each time the index metric is applied to the result, and further wherein each application of the index metric to a result is based on a different one of words and terms of the result, 2-gram shingles of the result, capitalized words of the result and words and terms grouped by paragraphs of the result. In some embodiments, if a query is greater than a finite length, dividing each of the queries into a plurality blocks less than or equal to the finite length, searching the databases based on each of the blocks, and combining block results found for each of the blocks into the set of results. In some embodiments, the searching of the one or more databases with the one or more queries related to the topic is performed periodically such that an updated set of results is returned based on the queries. In some embodiments, the method further comprises organizing the updated set of results into one or more updated hierarchical organizational structures based on the one or more inference metrics and selecting an updated subset of the updated set of results as updated representative results. In some embodiments, the method further comprises reorganizing the results into one or more updated hierarchical organizational structures based user input. In some embodiments, the databases are determined based on one or more of input from a user, one or more selected metrics or a subscription level associated with the user. In some embodiments, the representative results comprise at least one of a sentence, a document, a paragraph, a document and a keyword, wherein the sentence, the document, the paragraph and the keyword are not duplicative of each other. In some embodiments, the inference metric is based on one or more characteristics of the results selected from the group consisting of time of publication, source of the result, interaction of the result with other users, frequency of occurrence of the result in the set of results, frequency of occurrence of the result in the databases, frequency of occurrence of the result in one or more languages, frequency of occurrence of the result along with another result in the set of results, frequency of occurrence of the result along with the another result in the databases, frequency of occurrence of the result along with the another result in one or more languages, external associations between the result and the remainder of the set of results based on pre-defined dictionaries, grammatical classification of the result, the grammatical structure of the result, inclusion of pre-defined stop words in the result, scores or classifications of other results in the hierarchy, alignment to pre-defined hierarchies and the presence of other results within the results set.

### BRIEF DESCRIPTION OF THE DRAWINGS

FIG. 1 illustrates an electronic research process using a query-source model according to some embodiments.

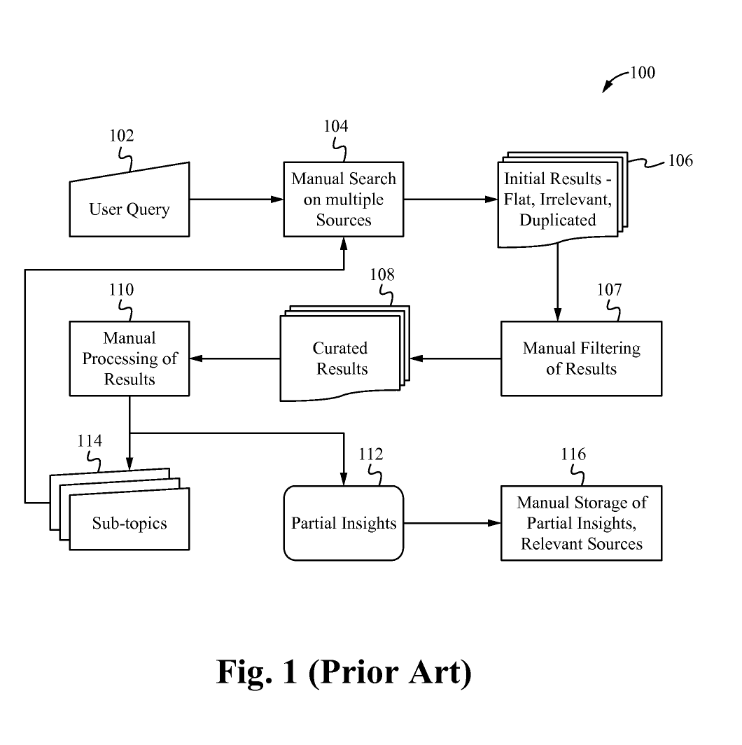

FIG. 2 illustrates a research system according to some embodiments.

FIG. 3 illustrates a block diagram of the research application or program according to some embodiments.

FIG. 4 illustrates a flow chart of one such method of removing duplicate elements that is able to be implemented by the basic filters according to some embodiments.

FIG. 5 illustrates a hierarchy of elements for a context according to some embodiments.

FIG. 6 illustrates the sentence metric used by the topical summarizer to determine relationship values for each sentence according to some embodiments.

FIG. 7 illustrates a phrase metric used to implement the logical dependencies builder to determine an inference score of the phrases according to some embodiments.

FIG. 8 illustrates a block diagram of an exemplary computing device configured to implement a digital carousel system according to some embodiments.

FIG. 9 illustrates a method of implementing a research system according to some embodiments.

FIG. 10 illustrates a method of scoring one or more push sources according to some embodiments.

### DETAILED DESCRIPTION OF THE INVENTION

The system, method and device for providing a research system described herein is directed to providing a query results hierarchy that captures logical dependencies in response to one or more user queries. Specifically, the research system comprises a searcher module, an inference module, a front-end module and an updater module. A user query is received by the front-end module and forwarded to the searcher and inference modules, which in addition to obtaining related results from one or more databases, filter and structure the results such that only highly relevant results are returned and that those results are already organized into one or more hierarchical structures for navigation by the user. In addition, the updater module is able to periodically cause any new data on the databases to be inputted by the search and inference modules and added to the existing results in order to maintain a fully updated results structure. As a result, the research system provides the benefit of creating faster, cheaper and more productive researching.

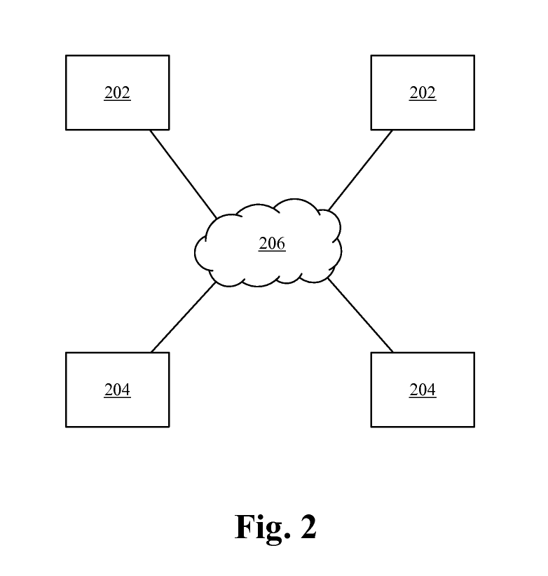

FIG. 2 illustrates a research system 200 according to some embodiments. As shown in FIG. 2, the system 200 comprises one or more servers 202 having a memory coupled with one or more client devices 204 over one or more networks 206. The networks 206 are able to be one or a combination of wired or wireless networks as are well known in the art. The one or more servers 202 are able to store at least one research application having a graphic user interface on the memory. As a result, a user is able to download the research application from the servers 202 over the network 206 onto one of the client devices 204 via a web browser on the client device 204 that is used to access the servers 202. After being downloaded to the client device 204, the application is able to use the local memory on the device 204 to store and utilize data necessary for operation of the research application in an application database.

Alternatively, some or all of the data is able to be stored in a server database on the servers 202 such that the application must connect to the servers 202 over the networks 206 in order to utilize the data on the server database. For example, the locally executing application is able to remotely communicate with the servers 202 over the network 206 to perform any features of the application and/or access any data on the server database not available with just the data on the application database. In some embodiments, the same data is stored on both the server database and the application database such that either local or remote data access is possible. In such embodiments, the databases are able to be synchronized by the research application. In some embodiments, the database and/or application is distributed across a plurality of the servers 202. Alternatively or in addition, one or more of the servers 202 are able to store all of the database and/or application data. In such embodiments, the servers 202 are able to perform a synchronization process such that all the databases and/or other application data are synchronized. Although as shown in FIG. 2 two servers 202 are coupled with two client devices 204, it is understood that any number of servers 202 are able to be coupled with any number of devices 204.

In some embodiments, the research application is able to be replaced or supplemented with a research website stored on the server memory and executed by the servers 202, wherein the website provides some or all of the functionality of the application with a website user interface that is substantially similar to the application user interface. In such embodiments, a client device 204 is able to access the website and utilize the features of the website with a web browser that communicates with the servers 202 over the networks 206. In some embodiments, the functionality of the website is able to be limited to facilitating the downloading of the application onto one or more client devices 204. For the sake of brevity, the following discussion relates to the functions and operation of application, the application user interface and the application database, however it is understood that the discussion is able to also relate to the function and operation of the website, the website user interface and the server database, or both. Additionally, although the operations of the research application and/or website are described herein as software, it is contemplated that some or all of the functions of the research application and/or website are able to be implemented with hardware via the servers 202 and/or devices 204.

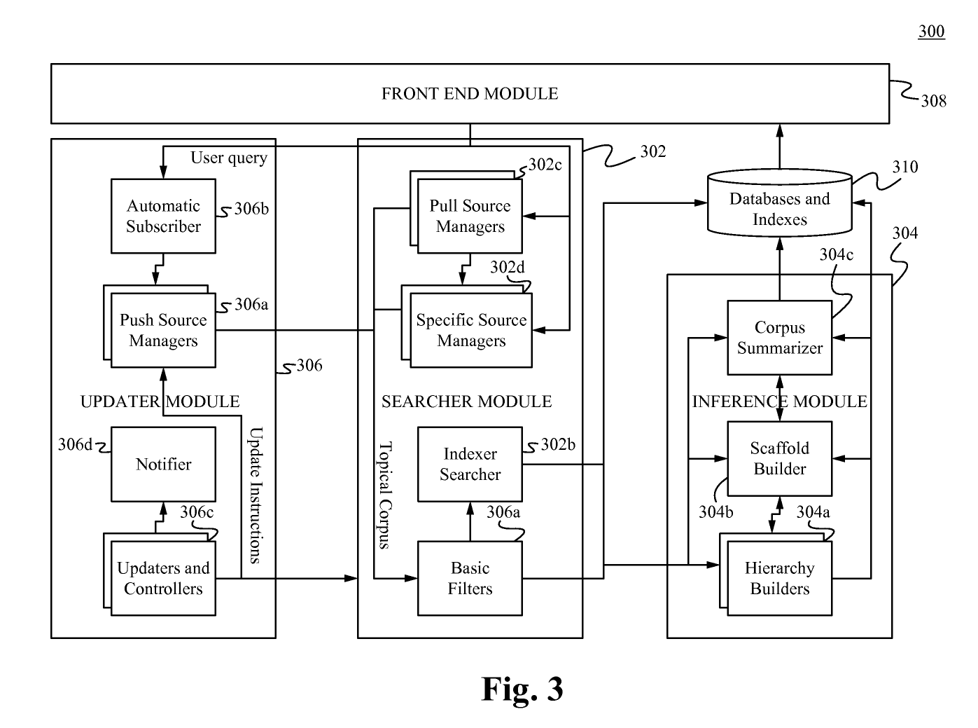

FIG. 3 illustrates a block diagram of the research application or program 300 according to some embodiments. As shown in FIG. 3, the research application 300 is able to comprise a searcher module 302, an inference module 304, an updater module 306, a front end module 308 and a research database 310. In some embodiments, one or more of the modules are able to be omitted and/or additional modules are able to be added.

### Searcher Module

The searcher module 302 is able to comprise one or more basic filters 302a, an indexer/searcher 302b, one or more pull source managers 302c and one or more specific source managers 302d. The basic function of the searcher module 302 is to search one or more data sources based on a selected topic or context and to gather one or more data elements or results from the sources related to the topic in order to form a topical corpus (e.g. set of data) associated with the topic.

In order to provide this functionality, the pull source managers 302c are each able to search one or more data sources based on one or more input user queries (received from the front end module 308). The number of and which sources searched by the pull source managers 302c is able to be based on one or more of the user query, the user access/subscription level, one or more selected search metrics, and/or selections of sources input by the user via the front end module 308. For example, a user is able to select or deselect one or more sources or metrics and those selected sources and/or sources associated with the selected search metrics are able to be searched by the searcher module 302. Alternatively, no selections need to be made by the user and based on the query, an access level associated with the user and/or a predetermined set of default sources the sources to be searched are able to be determined. In some embodiments, the selecting of sources feature provided by the front end module 308 to the user is able to be categorized such that a user is able to select one or more categories associated with a set of sources. For example, a user is able to select a finance category and/or recent events category such that only sources associated with finance and/or recent events are searched.

The specific source managers 302d operate similar to the pull source managers 302c except that the specific source managers 302d are able to be associated with custom data sources. In particular, the front end module 308 is able to enable users to upload a set of data and/or provide access to a set of data to form a custom source. For example, users dealing with publicly listed companies in United States may want to process documents filed with the Securities and Exchange Commission (SEC), and thus are able to use the front end module 308 to create a custom source including the desired SEC data by providing the data and/or providing access to the data. As a result, the searcher module 302 is able to create a specific source manager 302d associated with the custom source in order to search the data of the custom source when desired.

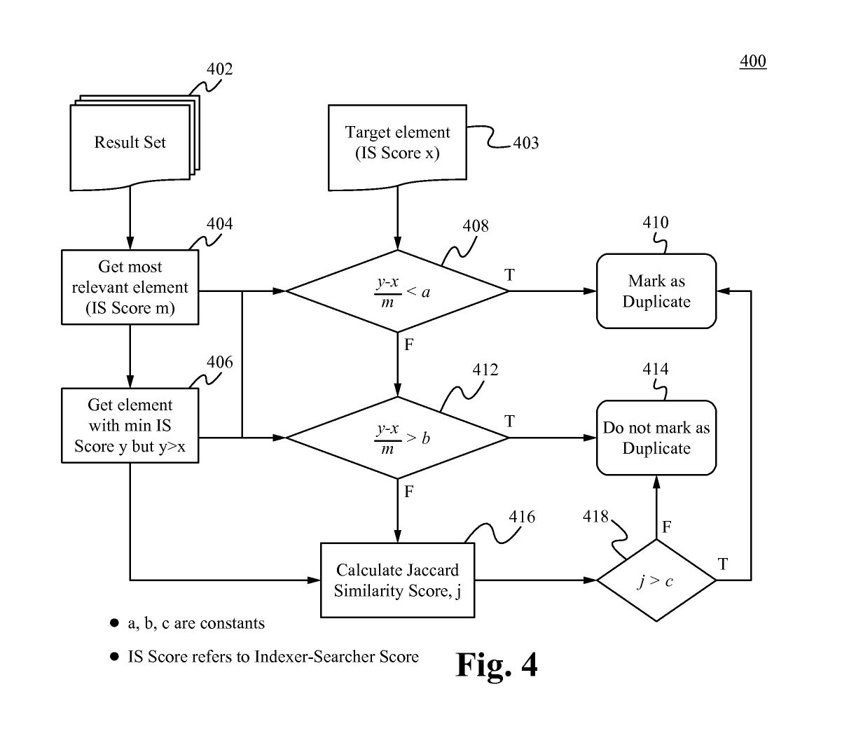

The basic filters 302a receive the set of data or topical corpus for a topic from the source managers 302c, 302d and 306a, curate or filter the content, and decide what elements of the corpus are sent to the indexer/searcher 302b for indexing. In some embodiments, the basic filters 302a filter the content by applying one or more relevance metrics to the content based on the topic or query. As a result, elements of the content that do not meet a relevance threshold value are able to be omitted or removed from the topical corpus. In some embodiments, the basic filters 302a filter the content by removing any duplicate or near duplicate elements or results within the content. FIG. 4 illustrates a flow chart of one such method 400 of removing duplicate elements that is able to be implemented by the basic filters 302a according to some embodiments. As shown in FIG. 4, the filters 302a set of elements for topical corpus from the managers 302c, 302d and 306a at the step 402. Each of these elements will have an associated indexer/searcher score (IS score) as determined by the indexer/searcher 302b via a relevance metric. In some embodiments, the IS score is determined for all of the elements prior to performing the method 400. Alternatively, the IS scores are able to be determined dynamically as needed by the method 400. The filters 302a select a target element having an IS score x from the set of elements at the steps 403. The filters 302a determine the score m of the element with the highest IS score at the step 404. Similarly, the filters 302a determine the score y of the element with the lowest IS score that is still greater than the score x of the target element at the step 406. In other words, the filters 302 determine the element with the closest (but greater) IS score to that of the target document.

Based on these scores, it is determined if the value y minus x divided by m is less than a predefined threshold value at the step 408. If the value is found to be less than the threshold a, the filters 302a identify the target element as a duplicate at the step 410. In other words, because the difference between the target element score and the closest but greater element score (as normalized by the maximum score) is less than the threshold value, it is determined that the two elements are duplicative and the less relevant target element is discarded as a duplicate. If instead the value is found to be greater than the threshold a, the filters 302a determine if the value is greater than a predefined threshold value b at the step 412. If the value is found to be greater than the threshold b, the filters 302a identify the target element as not being a duplicate at the step 414. If the value is found to be less than the threshold b, the filters 302a determine the Jaccard similarity score j of the target element and the element having the IS score y (e.g. the closest element) at the step 416. Alternatively, a different similarity algorithm is able to be used. The filters 302a determine if the value j is greater than the predefined threshold c at the step 418. If the value j is found to be greater than the threshold c, the method returns to step 410 and the target element is identified as a duplicate. Alternatively, if the value j is found to be less than the threshold c, the method returns to step 414 and the target element is not identified as a duplicate. Alternatively, steps 416 and 418 are able to be omitted. This process is able to be repeated for each element of the set of elements until each element has been treated as a target element and identified as a duplicate or non-duplicate. As a result, the filters 302a are able to remove duplicative elements from the set of data received from the managers 302c, 302d and 306a and prevent a user from sorting through the duplicative data.

The indexer/searcher 302b is able to index each element received from the basic filters 302a. In some embodiments, each element associated with a topic is indexed a plurality of times using different indexing methods such that the index list or combination of lists used to organize and/or locate elements within the corpus is able to be selected from the plurality of indexes created by the indexer/searcher 302b. For example, the indexer/searcher 302b is able to index elements i) as a normal index that considers words and terms, ii) as 2-gram shingles, iii) as a subset consisting of all the words that are capitalized in the element, iv) as words and terms grouped by paragraphs and/or v) only for names within the document. In contrast, Lucene only utilizes a single indexing method where each item is only indexed once. In some embodiments, the one or more indexes for a particular search and/or organization are able to be selected based on the context, the element, and/or the set of metrics under consideration. This enables faster and more efficient element searching/locating because the index chosen is able to be the most beneficial to the type of search or content sought.

In some embodiments, the indexer/searcher 302b uses a symmetric similarity metric to compare one or more target elements (e.g. a context) to another element. In particular, the symmetric similarity metric is configured such that the resulting score when comparing a context with another element produces the same score or value as if their places were reversed and the “another element” was inputted as the context and the “context” was inputted as the another element. For example, the score of a document (e.g. context) when a string (e.g. other element) is a query is same value as that of the string when the document is the query. In some embodiments, the symmetric similarity metric achieves this functionality by one or more of i) ignoring norm computations, ii) ignoring overlap between context and the element(s) and iii) ignoring any length-sensitive computations. In some embodiments, the symmetric similarity metric is substantially similar to the Lucene scoring method as is well known in the art, except for the differences described herein. As used herein, context and/or element are able to refer to one or more of a keyword; a phrase; a sentence; a paragraph and/or a whole document. Additionally, in some embodiments the indexer/searcher 302b replaces Inverse Document Frequency with Inverse Term Frequency.

In some embodiments, the indexer/searcher 302b is configured to be able to handle queries of arbitrary length. In particular, the indexer/searcher 302b is able to split any query that exceeds a predefined size threshold into a plurality of query blocks each having a maximum finite length of equal to or less than the size threshold. In some embodiments, the maximum finite length of the query blocks is equal to the size threshold. Alternatively, the maximum finite length is able to be less than the size threshold. In some embodiments, the query is divided such that the query blocks are the same size. Alternatively, one or more of the blocks are able to have different sizes (while still being less than the maximum finite length). Once the query blocks are created, the indexer searcher 302b initiates the queries for each individual block created, and then combines the query results from individual calls of each block to create a total query results set that corresponds to the total undivided query. As a result, in contrast to Lucene, the indexer/searcher 302b is able to handle queries larger than 1,024 characters.

In some embodiments, the indexer/searcher 302b is able to be adapted for a particular domain by a user. Specifically, the front end module 308 is able to input one or more domain specific elements (e.g. words) from a user such that the imputed elements are given more or less weight when indexing the elements. For example, certain domain specific stop words are able to be inputted from a user by the front end module 308 and transferred to the indexer/searcher 302b such that they are able to be ignored during the indexing process.

### Inference Module

The inference module 304 provides the function of selecting a subset of the topical corpus received from the searcher module 302, wherein the subset represents most or all the relevant data found in the topical corpus. In particular, the subset is able to be selected by structuring the topical corpus into one or more hierarchies and extracting the top layer or top nodes of one or more of the hierarchies as representative of the sub-nodes or sub-layers. This representative subset for a topic is then provided to a user upon a request for information about the topic received by the front end module 308. In other words, for a selected metric or metrics, the elements organized higher in a hierarchy (e.g. the top layer or top nodes) are more relevant according to the metrics for the selected topic or context than those relatively lower in the hierarchy (e.g. lower layers or sub-nodes). As a result, the inference module 304 provides the advantage of saving time by not presenting the entire topical corpus to a user such that they do not have to determine the relevant and most useful portions from a huge quantity of elements.

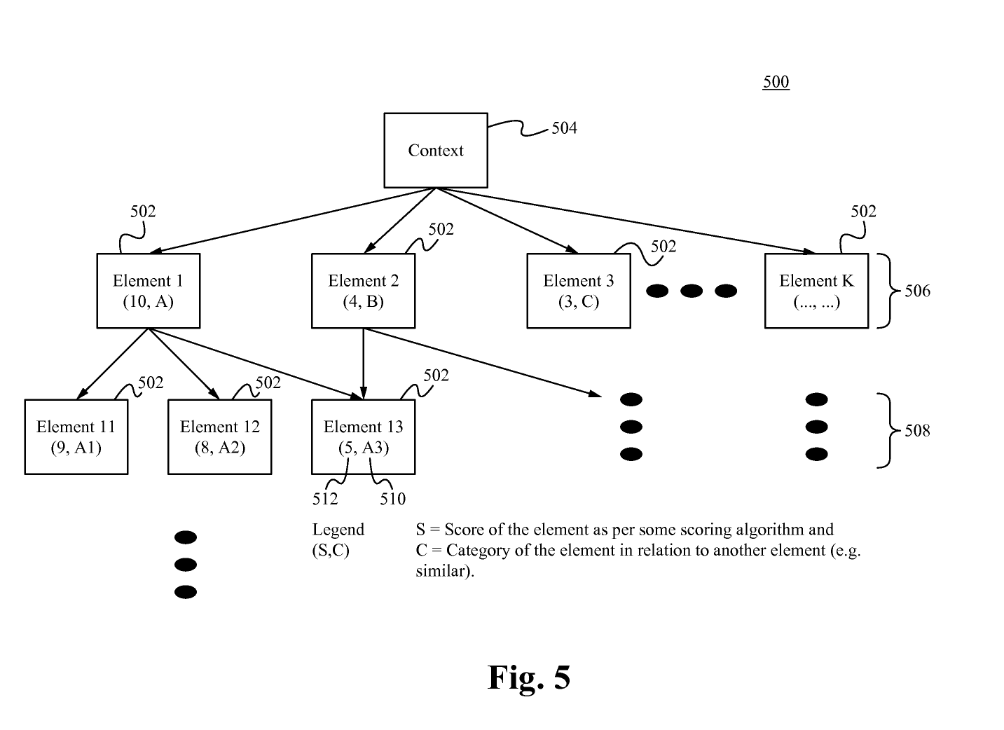

In order to provide this functionality, the inference module 304 is able to comprise one or more hierarchy builders 304a, a scaffold builder 304b and a corpus summarizer 304c. As shown in FIG. 5, the hierarchy builders 304a organize the elements 502 contained in the topical corpus of each topic or context 504 into different hierarchies 500 based on one or more metrics from a specified set of metrics. Specifically, the builders 304a are able to use a total corpus limiter feature that excludes or filters elements 502 from the topical corpus by arranging the elements 502 into a hierarchy 500 primarily defined by similarity of elements 502 to other elements 502 in the topical corpus. For example, elements 502 that within a similarity threshold value to each other on the basis of cosine similarity, Jaccard similarity and/or other metrics described herein or known in the art are designated to be within the same category 510 and subordinated in a sub-layer 508 to the newest element 502 in that category 510 such that only one element 502 per category 510 is within the top layer 506. This subordinating of elements 502 into sub-layers 508 is able to be performed regardless of a relevance score 512 of the elements 502 such that unlike other research systems, the elements 502 with the highest relevance score 512 are not always given priority over lower scoring elements 502. After the topical corpus has been organized into the hierarchy 500, the inference module 304 is able to simply select the elements 502 in the top layer 506 of the hierarchy 500 for the selected topic and provide only those items to a user. In some embodiments, the sub-layer 508 elements 502 are removed from the topical corpus for the topic. In some embodiments, when new information or elements received from the searcher module 302, the updater module 306 or a user via the front end module 308 includes a change in the set of inference metrics for generating the set of hierarchies, the inference module 304 is configured to modify the existing hierarchies instead of generating new hierarchies from scratch.

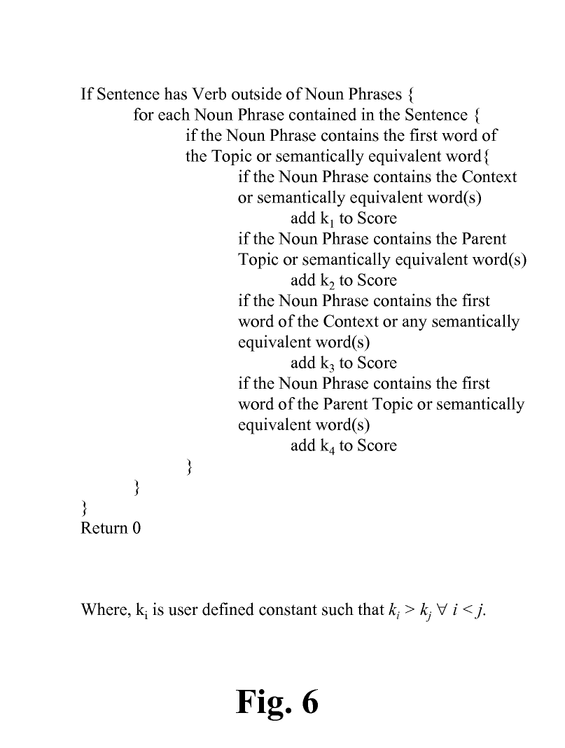

The builders 304a are also able to use a topical summarizer feature that organizes or ranks sentences of a topical corpus into a sentence hierarchy by strength of their relationship (according to a sentence metric) i) to the given topic, ii) with each other and iii) with key logical dependencies (important keywords, elements and/or ideas) of the topic. Such hierarchies are able to be used to categorize each of the sentences as one of i) Key Sentences (e.g. a set of sentences that contain most of the information related to the topic), ii) Representative Sentences (e.g. a subset of topical corpus that contains most of the relevant information about the topic) and iii) all other sentences. FIG. 6 illustrates the sentence metric 600 used by the topical summarizer to determine relationship values for each sentence according to some embodiments. In particular, first the topical summarizer identifies all noun phrases in one or more of the sentences. Then the topical summarizer determines the sentence metric score of each of the sentences, for example using the method 600 shown in FIG. 6. Finally, the topical summarizer uses the ranking or hierarchies in topical corpus limiter described above to find a set of representative sentences.

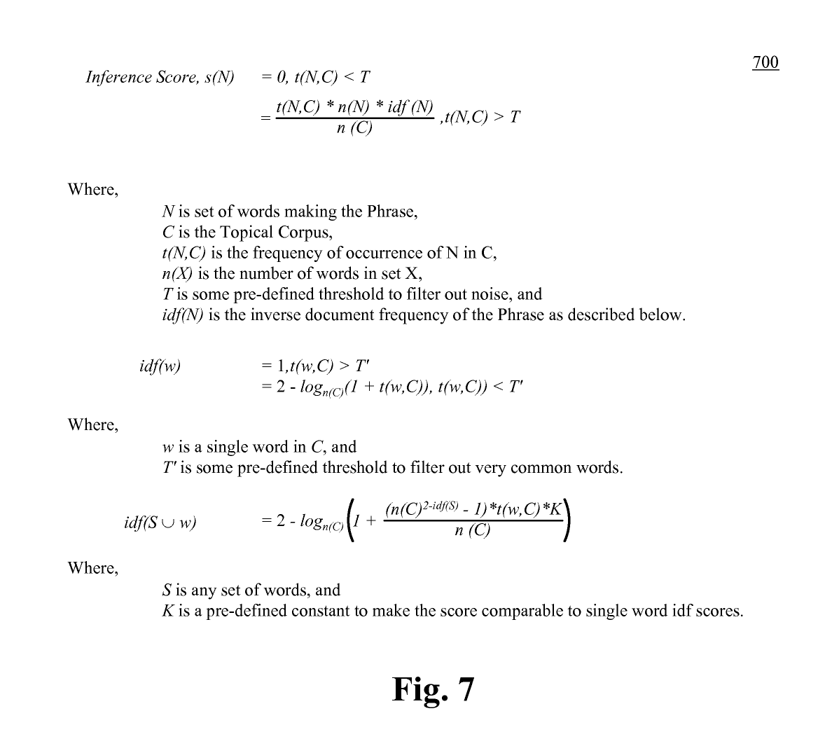

The builders 304a are also able to use a logical dependences builder features that organizes or ranks words or phrases (e.g. noun phrase) in the topical corpus into a phrase hierarchy for a topic into groups 1) grammatically related to each other and 2) by strength of the relationship of the groups to each other, to the topic, and to the words or phrases in the first layer of the hierarchy for the topic. FIG. 7 illustrates a phrase metric 700 used to implement the logical dependencies builder to determine an inference score of the phrases according to some embodiments. In particular, first the logical dependencies builder identifies all words or phrases in the topical corpus for the topic. Then the logical dependencies builder determines the phase metric score of each of the words or phrases, for example using the method 700 shown in FIG. 7. Finally, the logical dependencies builder uses the rankings or hierarchies in the topical corpus limiter, described above, to find possible logical dependencies and selects a predetermined number (e.g. up to 10) of the logical dependencies to classify them as key logical dependencies. Additionally, in some embodiments, the builders 304a are able to organize the topical corpus into one or more additional hierarchies. For example, a time hierarchy is able to be created to organize all elements in the topical corpus by the time of their publication. These different hierarchies provide the advantage of organizing the corpus into different structures that are each uniquely beneficial depending on the type of research that is being performed.

The scaffold builder 304b uses the hierarchy builders 304a and predefined domain specific templates to create logical taxonomies of all the elements related to a context or the “scaffold” of the context. This taxonomy is able to contain multiple folders or nodes related to the context. The top level nodes capture the most important ideas related to the context. Each node is able to recursively have multiple other sub-Nodes (in sub-layers) that capture the most important ideas related to the node and the context. The quantity of information or elements stored in each node is able to be adjusted from node to node, layer to layer or scaffold to scaffold such that the quantity is uniform or non-uniform as desired. In some embodiments, a scaffold is built based on the determined key logical dependencies being the sub-nodes, wherein the corpus summarizer (described below) is then used to associate unique summaries with each node and the topical corpus limiter is used to associate a unique representative corpus with each node.

The corpus summarizer 304c creates a summary for each results or element set of a topic. Specifically, the corpus summarizer 304c distils or identifies a small set of sentences from the topical corpus that have been determined to contain most of the information contained in the topical corpus for the topic. Further, for any given node in the scaffold related to a context, the corpus summarizer 304c uses one or more of the specific source managers 302d to find pre-defined information related to the node, if desired. For example, the pre-defined information is able to comprise a set of competitors for a company associated with the context. Alternatively, the summarizer 304c is able to omit the use of pre-defined information. Additionally, the summarizer 304c is able to use the representative sentences, as determined by the topical summarizer feature described above, as a part of the summary if there are no sub-nodes. Moreover, the summarizer 304c is able to run sub-nodes through the corpus summarizer 304 and use the set of key sentences, as determined by the topical summarizer feature described above, for each sub-node as summary. As a result, these summaries are able to be used to summarize the content of the topical corpus such that a researching user is saved time in their search.

### Front End Module

The front end module 308 comprises a user interface that is able to receive user input and present or provide results received from and/or created by the searcher module 302, the inference module 304 and/or the updater module 306 (and stored in the database 310) to the user in multiple formats that are able to be selectively navigated by the user. For example, in some embodiments the front end module 308 enables a user to enter a query or context and specify whether that context is a company, a person, a place, an industry or a set of keywords. In some embodiments, the front end module 308 highlights any changes to a set of results that have occurred since the user last viewed the results and/or that have occurred within a predefined period of time (e.g. within the last month). In particular, these changes are able to be the result of an update initiated by the updater module 306 wherein one or more new elements were input. These new elements are able to be input from sources, user input to the front end module 308 or a combination thereof. In some embodiments, the results/elements forming the selected portion of the hierarchies is presented visually to the user via the user interface such that the user is able to easily follow how the information related to a given context has evolved with the inflow of information. Further, in some embodiments the elements presented to the user as the output by the front end module 308 enable the user to navigate starting from one or more of the presented elements to explore the information related to that node (or set of elements) as well as its connection to the context.

### Updater Module

The updater module 306 is used to continuously cause the system 300 to update its indexes and hierarchies to reflect new elements or changes to elements from the sources and/or user input. As shown in FIG. 3, the updater module 306 is able to comprise one or more push source managers 306a, one or more automatic subscribers 306b, an updater/controller 306c and a notifier 306d. The push source managers 306a are configured to receive information from sources that push information to clients. The push source managers 306a are each associated with a particular push source (e.g. sources that disseminate information real time). As a result, the push source managers 306a are able to monitor the sources and inform the system 300 when new or different the information is available. Alternatively, the system 300 is able to prompt the push source managers 306a to gather the information. The push sources associated with the push source managers 306a are able to comprise one or more media feeds such as really simple syndication (RSS) feeds, Twitter feeds, email boxes or other types of push data sources. The information or elements received from the sources by the push source managers 306a is transmitted to the basic filters 302a where it is able to be processed similarly to the data from the pull and specific source managers 302c, 302d. Additionally, the push source managers 306a are able to be customized by a user similar to the customization of the pull and specific source managers 302c, 302d discussed above.

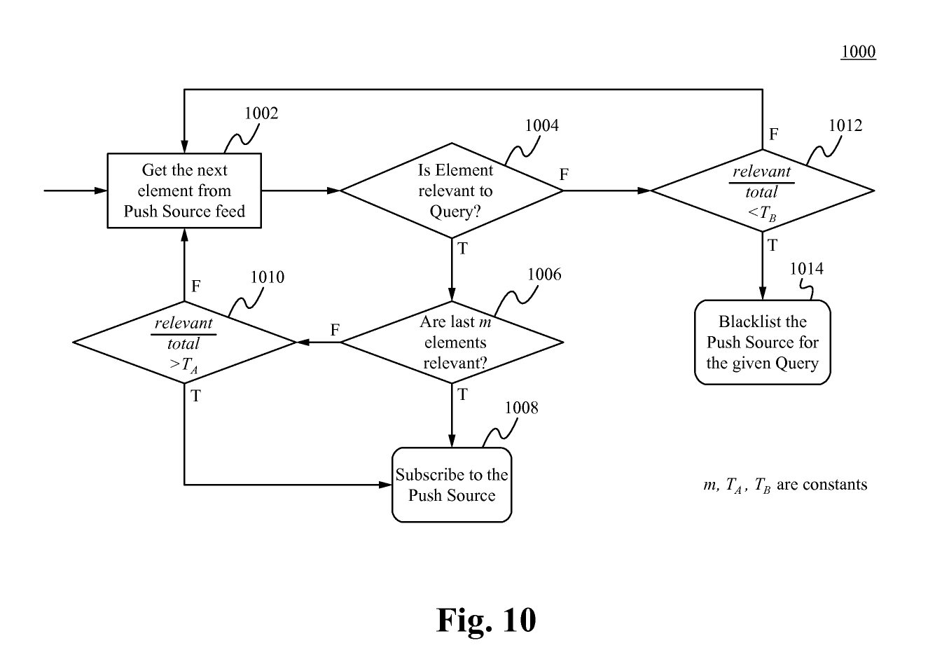

The automatic subscribers 306b are configured to automatically search and subscribe to relevant sources for the push source managers 306a to be associated with. Specifically, the subscribers 306b are able to search and identify all possible RSS feeds related to a topic based on one or more search engines, score each media feed as per the method 1000 described in FIG. 10 and select a predefined number of the highest scoring media feeds, and automatically subscribe for information from there such that a push source manager 306a is assigned to each of the predefined number of feeds. As shown in FIG. 10, the automatic subscribers 306b retrieve the next element from a push source feed at the step 1002. After retrieving the element, the automatic subscribers 306b determine if the element is relevant to one or more queries or topics at the step 1004. The relevancy determination is able to be based on one or more metrics, including any of the metrics described herein. If the element is determined to be relevant, the automatic subscribers 306b determine if a predefined number m of elements inputted and processed by the method 1000 have been determined to be relevant at the step 1006. In some embodiments, the elements must be a number m of sequential elements processed such that if one of the elements is the sequence is determined to not be relevant the count up to m elements is reset to zero. If the automatic subscribers 306b determine that the last m elements have all been determined to be relevant, the automatic subscribers 306b subscribe to the push source feed at the step 1008. If instead the automatic subscribers 306b determine that the last m elements have not all been determined to be relevant, the automatic subscribers 306b determine a fraction of the number of relevant elements that have been processed compared to the total number of elements that have been processed at the step 1010. In some embodiments, step 1010 is only performed once a predetermined number of elements have been processed to reduce the initial volatility of the fraction. In some embodiments, all of the elements that have been currently processed are used to determine the fraction value. Alternatively, only a predetermined number of the most recently processed elements are used to determine the fraction value. If the automatic subscribers 306b determine that the fraction is greater than a predefined threshold T_{A}, the method returns to step 1008 and the automatic subscribers 306b subscribe to the push source feed. If instead the automatic subscribers 306b determine that the fraction is not greater than the predefined threshold T_{A}, the method returns to step 1002 and the automatic subscribers 306b retrieve the next element from a push source feed. If at the step 1004 the element is determined to not be relevant, the automatic subscribers 306b determine a fraction of the number of relevant elements that have been processed compared to the total number of elements that have been processed at the step 1012. In some embodiments, step 1012 is only performed once a predetermined number of elements have been processed to reduce the initial volatility of the fraction. In some embodiments, all of the elements that have been currently processed are used to determine the fraction value. Alternatively, only a predetermined number of the most recently processed elements are used to determine the fraction value. If the automatic subscribers 306b determine that the fraction is less than the predefined threshold T_{B}, the method proceeds to step 1014 and the automatic subscribers 306b blacklist the push source feed such that it is removed from the potential pool of sources for the one or more queries or topics. In some embodiment, the source is removed permanently. Alternatively, the source is able to removed for a predefined period. If instead the automatic subscribers 306b determine that the fraction is not less than the predefined threshold T_{B}, the method returns to step 1002 and the automatic subscribers 306b retrieve the next element from a push source feed. As a result, the method 1000 is able to provide the advantage of determining the most beneficial push source feeds for incorporation in to the research system.

The updater/controller 306c is configured to issue requests/call or commands the inference module 304 to prompt the inference module 304 to update the hierarchies within the database 310 based on new or different elements that have been added to one or more of the topical corpuses. Specifically, the updater/controller 306c is able to assign each element retrieved from any source to any and all topical corpuses where it may belong based on the topic, and further is able to automatically call the inference module 304 to update the hierarchies associated with the topics. Additionally, in some embodiments the updater/controller 306c is able to prompt the pull source managers 302c and/or specific source managers 302d within the searcher module 302 to initiate new search. As a result, the updater/controller 306c is able to leverage the inference module 302 to update the set of hierarchies in the database 310.

The notifier 306d is configured to issue notification messages that indicate that new information/elements have been added to one or more topical corpuses and/or when a change or update has occurred with a topical corpus and/or the associated hierarchies. For example, a user is able to subscribe to one or more topics through the front end module 308 such that the notifier 306d will notify the user when the selected topics have been changed. The user is able to select the manner in which the notification is transmitted. For example, in some embodiments the notification is transmitted via an email message to an email address input by the user. Alternatively, the notification method is able to comprise emails, text messages, blinking of notification lights in smartphones, tablets or other devices storing the research application, asterisk in various components of the front end module 308 user interface and/or a combination thereof.

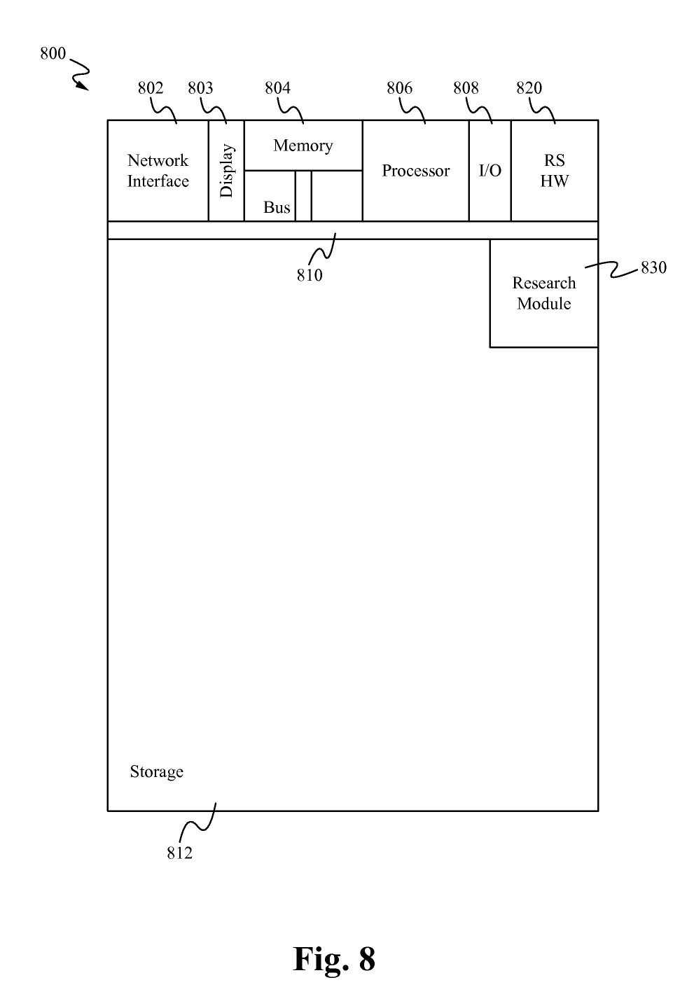

FIG. 8 illustrates a block diagram of an exemplary computing device 800 configured to implement a digital carousel system according to some embodiments. The computing device 800 is able to be one or more of the servers 202, one or more of the devices 204 and/or other computing devices that are able to acquire, store, compute, communicate and/or display information such as images and videos. For example, a computing device 800 is able to acquire and store a video. In general, a hardware structure suitable for implementing the computing device 800 includes a network interface 802, a display system 803, a memory 804, a processor 806, I/O device(s) 808, a bus 810 and a storage device 812. Alternatively, one or more of the illustrated components are able to be removed or substituted for other components well known in the art. The display system 803 is able to forward graphics, text, and other data from the communication infrastructure (or from a frame buffer not shown) for display on a display unit.

The choice of processor is not critical as long as a suitable processor with sufficient speed is chosen. The memory 804 is able to be any conventional computer memory known in the art. The storage device 812 is able to include one or more of a hard drive, CDROM, CDRW, DVD, DVDRW, flash memory card or any other storage device. The computing device 800 is able to include one or more network interfaces 802. An example of a network interface includes a network card connected to an Ethernet or other type of LAN. Other examples of network interfaces include a modem, a communication port, or a PCMCIA slot and card. Software and data transferred via network interface 802 are able to be in the form of electronic, electromagnetic, optical, or other signals capable of being received by communication interface. These signals are provided to communication interface via a communication path (i.e., channel). This communication path carries signals and may be implemented using wire or cable, fiber optics, a phone line, a cellular phone link, an RF link, and/or other communication channels.

The I/O device(s) 808 are able to include one or more of the following: keyboard, mouse, monitor, display, printer, modem, touchscreen, button interface and other devices. Research application(s) or module(s) 830 used to operate the application or downloadable application are likely to be stored in the storage device 812 and memory 804 and processed as applications are typically processed. More or less components shown in FIG. 8 are able to be included in the computing device 800. In some embodiments, research system hardware 820 is included. Although the computing device 800 in FIG. 8 includes applications 830 and hardware 820 for the research system, the research system method is able to be implemented on a computing device in hardware, firmware, software or any combination thereof.

In some embodiments, the research application(s) 830 include several applications and/or modules. In some embodiments, the research application(s) 830 include a separate module for each of the graphical user interface features described above. The modules implement the method described herein. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a Blu-ray® writer/player, a television, a home entertainment system or any other suitable computing device.

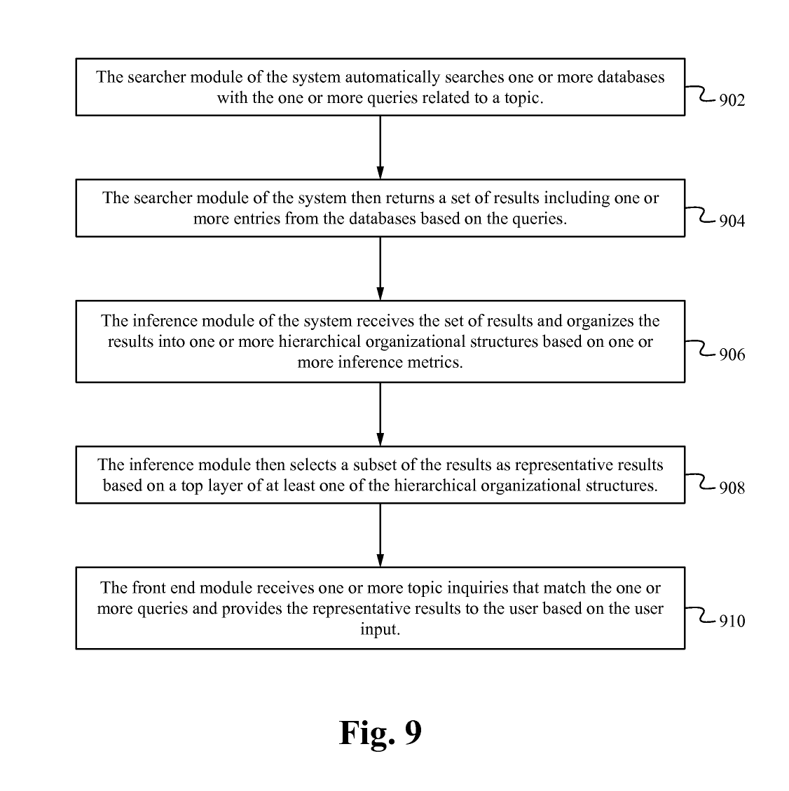

FIG. 9 illustrates a method of implementing a research system according to some embodiments. As shown in FIG. 9, the searcher module of the system automatically searches one or more databases with the one or more queries related to a topic at the step 902. The searcher module of the system then returns a set of results including one or more entries from the databases based on the queries at the step 904. The inference module of the system receives the set of results and organizes the results into one or more hierarchical organizational structures based on one or more inference metrics at the step 906. The inference module then selects a subset of the results as representative results based on a top layer of at least one of the hierarchical organizational structures at the step 908. The front end module receives one or more topic inquiries that match the one or more queries and provides the representative results to the user based on the user input at the step 910. In some embodiments, steps 902-908 are able to be performed after the front end module receives the one or more topic inquiries in the step 910. In some embodiments, the updater module provides new results and/or new data and causes the searcher module and/or the inference module to update the hierarchical organizational structures based on the new results and/or data. In some embodiments, one or more of the steps are able to be omitted. As a result, the method provides the benefit of reducing research time and effort by providing pre-filtered results that represent the most relevant information to a topic.

The research system, method and system described herein provides the benefit of enabling users to save time by automatically identifying key logical dependencies of a context or topic and other key logical dependencies, which often leads to unique insights and reduces reliance on human judgment. In some embodiments, a typical context has more than 1,000 nodes in the associated scaffold, leading to depth, which is not possible otherwise. Further, the system automatically searches multiple Sources for each of the key logical dependencies, which is usually impractical without using the system. In some embodiments, the system uses more than 1,000 to search for information related to each node in a scaffold related to the context, leading to breadth, which is not possible otherwise. Further, the system removes all duplicated content at all levels so that each element of the output is unique and significant. In some embodiments, only one document is presented out of typically 800 documents found from the sources, leading to efficiency, which is not possible otherwise. Further, the system extracts summaries so that users can focus on processing the information rather than aggregating relevant information from the topical corpus, leading to higher productivity and better answers from the research. Further, the system automatically prioritizes information that is more important than others, leading to better time management by users, especially on busy days with a lot of information flow. Further, the system automatically updates hierarchies and dependent outputs, which often leads to identification of new key logical dependencies. In some embodiments, certain sources are searched every five minutes and the user notified of new information, relieving the user of the burden to constantly check the sources themselves, and presenting them with latest information. Thus, the system significantly reduces costs while increasing the benefits of research.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims. For example, it is contemplated that one or more of the functions performed by the research application described herein are able to be performed by purely software, purely hardware, or a combination of hardware and software. Further, the elements described herein are able to be video and/or audio data that is converted to textual data by way of, for example, using the closed caption or by utilizing a speech extraction software.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.” The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising” and/or “consists,” when used in this specification, specify the presence of stated features, steps, operations, elements, and/or components, but do not preclude the presence or addition of one or more other features, steps, operations, elements, components, and/or groups thereof.

The term “Metric” as used herein is able to refer to a scoring, ranking and/or classifying algorithm or equation that is able to be applied to one or more elements. Each metric is able to incorporate one or more variable or attribute values in order to determine an output value. For example, the variables/attributes are able to comprise: time of publication of the element; source of the element; interaction of the element with other users; the frequency of occurrence of the element in the topical corpus, databases maintained by service providers, databases maintained by the user and any corpus representing a written language like English; frequency of occurrence of the element along with another element, within other larger elements, for example, frequency of co-occurrence of two words in sentences; external associations between elements as per pre-defined or user-defined dictionaries, for example, equivalence of the ticker and name of a publicly listed company; classification of the element as per grammar, for example, part of speech for English words; conformance of the element to certain grammatical constructs, for example, whether an English sentence contains a verb outside of noun clauses; inclusion of pre-defined stop words in the element; scores or classifications of other elements in a hierarchy; and alignment to pre-defined or user-defined hierarchies; the presence of other elements, for example, a duplicated document.

The term “sources” as used herein is able to refer to one or more of other search engines; websites such as blog sites, company website, news publishers; social media such as Twitter; rich site summary (RSS) feeds; third party database services and subscriptions like Capital IQ, Gartner, Bloomberg and others; individual or shared email repositories; individual or shared electronic files; proprietary or third party software that is used to manage research, notes, contacts and other third party data; private information repositories and other sources of information that may be specific to individual situations.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A research system stored on a non-transitory computer-readable medium, the system comprising:
a searcher module that automatically searches one or more databases with one or more queries related to a topic and returns a set of result elements including one or more entries from the databases based on the queries;
an inference module that organizes the result elements into one or more hierarchical organizational structures based on one or more inference metrics and selects a subset of the result elements as representative results based on a location of the elements in at least one of the hierarchical structures; and
a front end module that is capable of accepting user inputs and only provides the representative results to the user.

2. The system of claim 1 wherein organizing the results comprises categorizing each of the results and assigning a predefined number of the results in each category to the top layer of one of the hierarchical organizational structures.

3. The system of claim 1 wherein the inference module organizes the results by ranking each of the sentences within the results according to a sentence metric value of each of the sentences, wherein the sentence metric value is determined according to a sentence metric based on comparing one or more of:
the sentence and the topic;
the sentence and other sentences within the results; and
the sentence and a set of keywords related to the topic.

4. The system of claim 1 wherein the inference module organizes the results by ranking each of the words within the results according to a word metric value of each of the words, wherein the word metric value is determined according to a word metric based on comparing one or more of:
the word and the topic; and
the word and other words within the results.

5. The system of claim 1 wherein the subset of the elements of the hierarchies is the elements located at the top of at least one of the hierarchical organizational structures.

6. The system of claim 1 wherein the topic and each of the results is one or more of the following: a document, a paragraph, a sentence, a phrase or a word, and further wherein the topic is one or more of a document, a paragraph, a sentence, a phrase or a word.

7. The system of claim 1 wherein the search module automatically removes duplicates from the results by removing those results that have a metric score whose value when subtracted from the next highest metric score of an element of the results is below a threshold value, wherein the metric scores are determined based on an index metric.

8. The system of claim 7 wherein the index metric is symmetric such that the score of two of the elements is independent of the order in which the two elements are compared.

9. The system of claim 7 wherein the searcher module applies the index metric to each of the results a plurality of times such that each of the results has a separate metric score for each time the index metric is applied to the result, and further wherein each application of the index metric to a result is based on a different one of:
words and terms of the result;
2-gram shingles of the result;
capitalized words of the result; and
words and terms grouped by paragraphs of the result.

10. The system of claim 1 wherein if a query is greater than a finite length, the searcher module divides each of the queries into a plurality blocks less than or equal to the finite length, searches the databases based on each of the blocks, and combines the individual results found for each of the blocks to construct a final result.

11. The system of claim 1 further comprising an updater module that automatically causes the searcher module to periodically search the one or more databases with the one or more queries related to the topic and returns an updated set of results based on the queries.

12. The system of claim 11 wherein the inference module organizes the updated set of results into one or more updated hierarchical organizational structures based on the one or more inference metrics and selects an updated subset of the newly constructed set of results as representative outputs.

13. The system of claim 11 wherein the inference module reorganizes the results into one or more updated hierarchical organizational structures based on a user input received through the front end module.

14. The system of claim 1 wherein the databases are determined based on one or more of input from a user, one or more selected metrics or a subscription level associated with the user.

15. The system of claim 1 wherein the representative results comprise plurality of elements consisting of sentences, documents, paragraphs, keywords without duplicates.

16. The system of claim 1 wherein the inference metric is based on one or more characteristics of the results selected from the group consisting of time of publication, source of the result, interaction of the result with other users, frequency of occurrence of the result in the set of results, frequency of occurrence of the result in the databases, frequency of occurrence of the result in one or more languages, frequency of occurrence of the result along with another result in the set of results, frequency of occurrence of the result along with the another result in the databases, frequency of occurrence of the result along with the another result in one or more languages, external associations between the result and the remainder of the set of results based on pre-defined dictionaries, grammatical classification of the result, the grammatical structure of the result, inclusion of pre-defined stop words in the result, scores or classifications of other results in the hierarchy, alignment to pre-defined hierarchies and the presence of other results within the results set, and/or any other Natural Language Processing based criteria.

17. A method of implementing a research system, the method comprising:
with a computing device:
automatically searching one or more databases with one or more queries related to a topic and returning a set of results including one or more entries from the databases based on the queries;
organizing the results into one or more hierarchical organizational structures based on one or more inference metrics and selecting a subset of the results as representative results based on a top layer of at least one of the hierarchical organizational structures; and
receiving user inputs and only providing the representative results to the user.

18. The method of claim 17 wherein organizing the results comprises categorizing each of the results and assigning a predefined number of the results in each category to the top layer of one of the hierarchical organizational structures.

19. The method of claim 17 wherein the organizing of the results comprises ranking each of the sentences within the results according to a sentence metric value of each of the sentences, wherein the sentence metric value is determined according to a sentence metric based on comparing one or more of:
the sentence and the topic;
the sentence and other sentences within the results; and
the sentence and a set of keywords related to the topic.

20. The method of claim 17 wherein the organizing of the results comprises ranking each of the words within the results according to a word metric value of each of the words, wherein the word metric value is determined according to a word metric based on comparing one or more of:
the word and the topic; and
the word and other words within the results.

21. The method of claim 17 wherein the subset is a set number of the results at the top of one of the hierarchical organizational structures.

22. The method of claim 17 wherein each of the results is one of a document, a paragraph, a sentence, a phrase or a word, and further wherein the topic is one or more of a document, a paragraph, a sentence, a phrase or a word.

23. The method of claim 17 further comprising automatically removing duplicate results from the results by removing each of the results that have a metric score whose value when subtracted from the next highest metric score of a results of the results is below a threshold value, wherein the metric scores are determined based on an index metric.

24. The method of claim 23 wherein the index metric is configured such that a first metric score of one of the results based on another of the results is equal to a second metric score of the another of the results based on the one of the results.

25. The method of claim 23 further comprising applying the index metric to each of the results a plurality of times such that each of the results has a separate metric score for each time the index metric is applied to the result, and further wherein each application of the index metric to a result is based on a different one of:
words and terms of the result;
2-gram shingles of the result;
capitalized words of the result; and
words and terms grouped by paragraphs of the result.

26. The method of claim 17 wherein if a query is greater than a finite length, dividing each of the queries into a plurality blocks less than or equal to the finite length, searching the databases based on each of the blocks, and combining block results found for each of the blocks into the set of results.

27. The method of claim 17 wherein the searching of the one or more databases with the one or more queries related to the topic is performed periodically such that an updated set of results is returned based on the queries.

28. The method of claim 27 further comprising organizing the updated set of results into one or more updated hierarchical organizational structures based on the one or more inference metrics and selecting an updated subset of the updated set of results as updated representative results.

29. The method of claim 27 further comprising reorganizing the results into one or more updated hierarchical organizational structures based user input.

30. The method of claim 17 wherein the databases are determined based on one or more of input from a user, one or more selected metrics or a subscription level associated with the user.

31. The method of claim 17 wherein the representative results comprise at least one of a sentence, a document, a paragraph, a document and a keyword, wherein the sentence, the document, the paragraph and the keyword are not duplicative of each other.

32. The method of claim 17 wherein the inference metric is based on one or more characteristics of the results selected from the group consisting of time of publication, source of the result, interaction of the result with other users, frequency of occurrence of the result in the set of results, frequency of occurrence of the result in the databases, frequency of occurrence of the result in one or more languages, frequency of occurrence of the result along with another result in the set of results, frequency of occurrence of the result along with the another result in the databases, frequency of occurrence of the result along with the another result in one or more languages, external associations between the result and the remainder of the set of results based on pre-defined dictionaries, grammatical classification of the result, the grammatical structure of the result, inclusion of pre-defined stop words in the result, scores or classifications of other results in the hierarchy, alignment to pre-defined hierarchies and the presence of other results within the results set.
